(19) United States
(12) Patent Application Publication
(10) Pub. No.: US 2002/0077766 A1
(43) Pub. Date: Jun. 20, 2002

(54) Remote temperature monitoring system

(76) Inventor: James R. Mault, Evergreen, CO (US)

Correspondence Address: Gifford, Krass, Groh, Sprinkle, Anderson & Citkowski, P.C., Suite 400, 280 N. Old Woodward, Birmingham, MI, 48009, US

(21) Appl. No.: 10/014,646

(22) Filed: Dec. 11, 2001

Related U.S. Application Data
(60) Provisional application No. 60/254,911, filed on Dec. 11, 2000.

(30) Foreign Application Priority Data
May 4, 2001 (US) PCT/US01/40678

(51) Int. Cl. G06F 15/00

(52) U.S. Cl. 702/131

(57) ABSTRACT

A system for monitoring and recording the body temperature of a subject includes a thermal sensor adapted to be supported in contact with the subject's body, a microprocessor based programmable information appliance having a display, and an application program for the appliance adapted to process the electrical signals generated by the sensor and time signals to create a display constituting a plot of body temperature versus time. The information used to generate the display may be transmitted to a remote computer for access by healthcare professionals over a public network and feedback information can be provided over the public network to the display of the information appliance.

### RELATED APPLICATION

This application claims priority of U.S. Provisional Patent Application 60/254,911 filed Dec. 11, 2000, and PCT Patent Application PCT/US01/40678 filed May 4, 2001, and is incorporated herein by reference.

### FIELD OF THE INVENTION

This invention relates to a system for sensing the body temperature of a subject and transferring the information to a microprocessor based information appliance for display of a time-temperature plot, and more particularly to such a system which can transmit the information to a remote computer over a public network for access by a healthcare professional.

### BACKGROUND OF THE INVENTION

Body temperature is a basic measurement of mammalian wellness since elevated temperature is a common symptom of disease. For a variety of reasons, temperature variation over a period of time is a more meaningful measurement of mammalian condition than a single temperature measurement at a selected time. For example, while 98.6° C. is often referred to as “normal” human body temperature, this normal temperature may vary among individuals over a relatively wide range. Some individuals may have usual or normal body temperatures of 96° C. so that 98.6° C. would be considered an elevated temperature. Moreover, the variation in body temperature over time as a disease progresses is a meaningful measurement to healthcare professionals. Increase in body temperature over time is often associated with an inception of a disease while decrease in body temperature over time may be typical during recovery from a disease. Accordingly, body thermometers have been proposed which can be used to periodically measure temperature and record the temperature and the time of measurement and generate a display of temperature over a period of time. U.S. Pat. No. 4,771,791 discloses a system of that type. Other systems utilize a temperature sensor associated with the body which may wirelessly transmit information to a specialized appliance for display, such as U.S. Pat. Nos. 5,938,619; 6,238,354 and 6,030,342.

In recent years a number of microprocessor based, programmable devices having displays have been developed for individual use and become widely available within households. These devices include personal computers of both the desktop and laptop variety; Personal Digital Assistants (PDAs) which are handheld, microprocessor based devices having displays and storage such as Palm type devices; sophisticated cellular phones with programmable displays and the like; and interactive TV systems usually embodied in set top boxes. All of these devices, hereinafter termed “information appliances”, can be equipped with application programs for performing a variety of tasks. They all have means for receiving data either by means of plug-in ports or wirelessly, and many have means for transmitting data to public networks such as the telephone network or the Internet, to provide data to remote computers.

### SUMMARY OF THE PRESENT INVENTION

The present invention is directed toward a system for monitoring and recording the body temperature of a subject, preferably a human, which employs a thermal sensor supported in contact with the body to generate electrical signals representative of the body temperature, means for transmitting those signals to a standard household type information appliance for generation of a plot representing body temperature over time on the display of the information appliance, and to information appliances equipped with a specialized application program for receiving the data from the sensor and from a clock and for generating the plot. The system of the present invention includes a clock adapted to generate electrical signals as a function of time either in association with a thermal sensor on the subject's body or as part of the information appliance. This arrangement eliminates the need for a dedicated, special purpose appliance as required by the prior art and utilizes information appliances already available in households for other purposes.

The information appliance may also include means for connecting to a public network, such as the Internet, either wirelessly or through a wired connection, which allows the time/temperature information to be transmitted to a remote computer, typically a server on the Internet, where it can be made available to healthcare professionals such as physicians.

Typical use of the system of the present invention would be to monitor the temperatures of infants and small children. Often a parent becomes alarmed by an elevated temperature and phones or visits a healthcare professional. The present invention would make available to the professional a plot of temperature over time either by the parents bringing the information appliance or a printout from the appliance containing the plot during a visit to the physician or through the physician viewing the plot on a website to which the information has been transmitted. This will allow a more informed decision by the physician on the course of treatment.

In the preferred embodiment of the invention, the system includes a memory associated with the sensor on the body of the subject which receives electrical signals from the temperature sensor and from the clock so as to record the time of occurrence of the electrical signals representative of body temperature and store them. The stored information may then be transferred to the information appliance either by a direct wire connection, by transfer of a memory element from the body mounted unit to the information appliance, or wirelessly. Similarly, communication between the information appliance and a public network such as the Internet may be achieved wirelessly or through a wired connection.

Information from the temperature sensor, whether transmitted at intervals dictated by the information appliance or stored and then delivered to the information appliance, could be provided directly to an information appliance in the form of a television set top box (which functionality might be built into the television set or, alternatively, information from the body mounted sensor could be provided to an information appliance in the form of a PDA and then transmitted to the interactive TV receiver for display and for transmission to a remote website.

### BRIEF DESCRIPTION OF THE DRAWING

Other objects, advantages and applications of the present invention will be made apparent by the following detailed description of embodiments of the invention. The description makes reference to the drawings in which:

FIG. 1 is a schematic diagram of a preferred embodiment of the invention, illustrating a temperature sensor supported on an infant and the wireless transmission of temperature information collected by the sensor to a PDA held by an adult, and transmission of the information from the PDA, over the Internet, to a remote computer for review by a professional;

FIG. 2 is a schematic diagram of the electronics of the system of FIG. 1, illustrating alternative arrangements for transferring information from a memory supported on the infant's body to the PDA;

FIG. 3 is a block diagram of the electronics within the PDA;

FIG. 4a is an illustration of the PDA;

FIG. 4b is an illustration of a laptop computer which might be used as an alternative to a PDA;

FIG. 4c is an interactive TV receiver which might be used as an alternative to a PDA;

FIG. 5 is a perspective drawing of a temperature sensor affixed to a strap for attaching it to a body member; and

FIG. 6 is a side view of the sensor of FIG. 5 illustrating details of its construction.

### DETAILED DESCRIPTION OF THE PREFERRED EMBODIMENTS

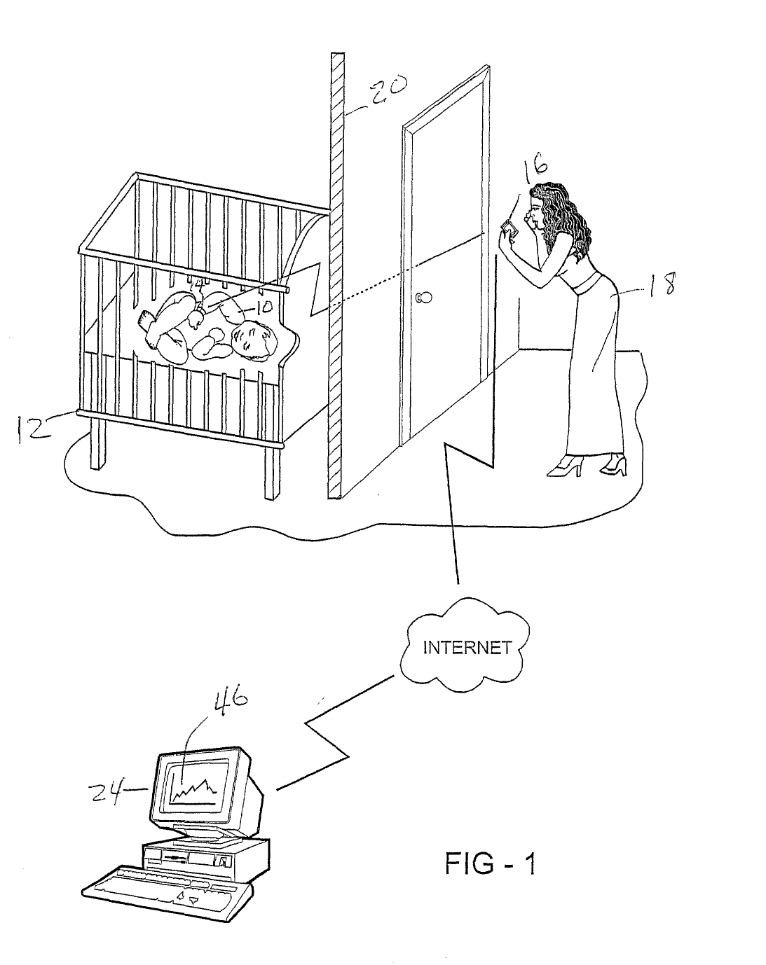

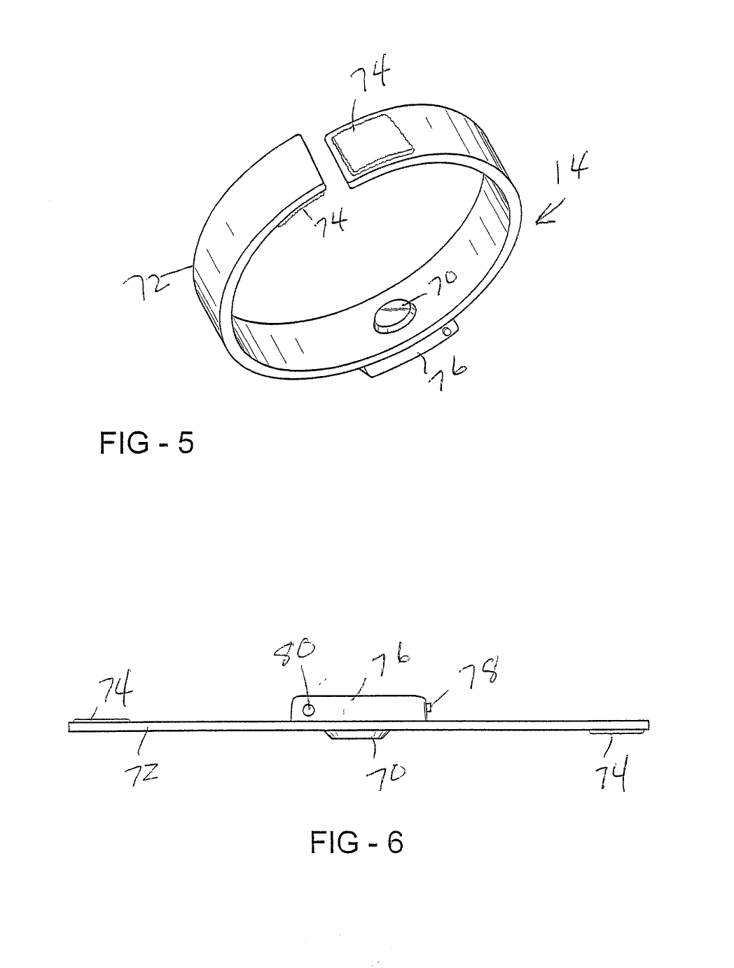

Referring to the drawings, a typical use of the system of the present invention is illustrated in FIG. 1. An infant 10, lying in a crib 12, has a temperature sensor 14 strapped to its arm. The temperature sensor may be of the type illustrated in FIGS. 5 or 6 which involve a Velcro strap adapted to surround the limb. Alternatively, the temperature sensor could be supported on other body parts, such as under the arm, in the groin, or the like with pressure sensitive adhesives, adhesive tape securing devices, or attachment to the inner sides of undergarments such as diapers. The sensors could also be secured to the user's body by insertion in body orifices such as ears. Alternatively, the temperature sensor could be supported in close separation to a body part so as to detect the temperature thereof by infrared radiation or the like. The following terms such as “. . . supported in contact with the body of the subject . . . ” are intended to refer to any of these support methods.

In a manner which will be subsequently described, the temperature information, and alternatively time of temperature occurrence information, from the sensor 14 is provided to a personal digital assistant 16, supported remotely from the crib 12. In FIG. 1 the PDA 16 is illustrated as being supported by an adult 18 in a room separated from the crib 12 by a wall 20. The PDA 16 is a species of what will be generically termed hereinafter an “information appliance” or “household information appliance”. Other species of this generic class of device will be detailed subsequently.

The PDA 16 is adapted to generate a time/temperature plot of the body temperature detected by the sensor 14 on its display 22. This allows the user 18 to make a diagnostic judgment as to whether the temperature is increasing or decreasing over time or whether the temperature is at what is considered to be an elevated level.

Electrical signals representative of the time/temperature plot stored in the PDA 16 may be transmitted to a remote computer 24. FIG. 1 illustrates the transmission through the Internet. The information in the PDA may be transmitted wirelessly to the Internet; the information could be provided from the PDA to a personal computer connected to the Internet; or the transmission might be through an interactive TV receiver connected to the Internet as will be subsequently described. Other forms of networks such as a telephone network might be used to transmit the information from the PDA 16 to a remote computer 24.

The computer 24 may be a website on the Internet which may be accessed by an authorized professional such as a pediatrician or the like. The adult 18 supervising the temperature collection might e-mail or phone the professional and advise of the availability of the time/temperature plot for the infant 10 being available in the remote computer 24. The professional, after reviewing the information on the computer 24, can communicate with the adult 18 by phone, e-mail or the like and the e-mail message may be generated on the display 27 of the information appliance such as the PDA 16.

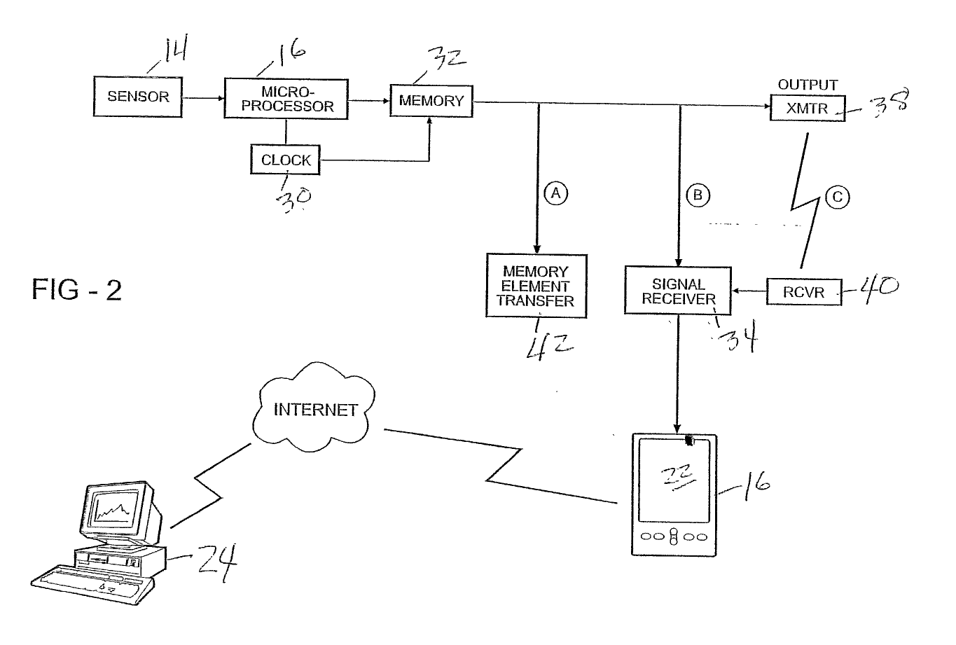

An electrical schematic diagram of the system of FIG. 1 is illustrated in FIG. 2. The sensor 14 provides its electrical output to a microprocessor 16 supported on the body of the infant 10 in association with the sensor. The system also includes a real time clock 30, which provides its output to the microprocessor 16. Alternatively, the clock 30 could be an integral part of the microprocessor. The microprocessor senses the output of the sensor 14 at regular intervals, such as each quarter hour, and provides the sensor signals to a memory 32 which also receives signals representative of the time of occurrence of the sensor signal, from the clock 30. The memory is preferably of a nonvolatile variety such as a flash memory. The body mounted assembly might include a battery, preferably of the strip type, to power the operation (not shown).

The memory 32 stores a record of temperatures measured by the sensor 14 at periodic times and the time of occurrence of the temperature measurement. This information must be transferred to a receiver 34 associated with the information appliance 16. The receiver may be formed integrally with the information appliance 16 or may be externally connected thereto. Three methods of transmission of the information from the body supported memory 32 to the signal receiver 34 are contemplated. First, a direct wired connection may be made using a cable 36. As will be described in detail, the sensor is preferably equipped with a female socket allowing the cable to be interconnected and to retrieve the signals stored in the memory. A second method of communication would be wirelessly. The body mounted unit could be equipped with a data transmitter 38, which could include the Blue Tooth variety or some other short range radio frequency or infrared communication, to a data receiver 40, forming part of the signal receiver 34. The infrared communication may be of the type used to communicate between two Palm type PDAs. A third form of communication would be to remove a memory module 42 from the memory 32 and insert it in a suitable port in the signal receiver. This might be flash memory of the type sold by Sony under the trademark “Memory Stick”. It comprises a compact module which may be inserted into and removed from a receptacle in order to transfer information between two devices. Other forms of memory transfer of the type used with digital cameras could be employed.

The signal receiver 34 provides the time stamped temperature signals to the information appliance 16. As will be subsequently noted, the information appliance 16 includes an application program which operates under the control of the operating system for the information appliance to generate a time/temperature plot of the signals transferred from the body supported unit. The plot is schematically illustrated at 46 in FIG. 1. The information appliance 16 displays the time/temperature plot on its display screen 22. It also preferably includes an application program which allows the information to be transmitted to the remote computer 24 via the Internet.

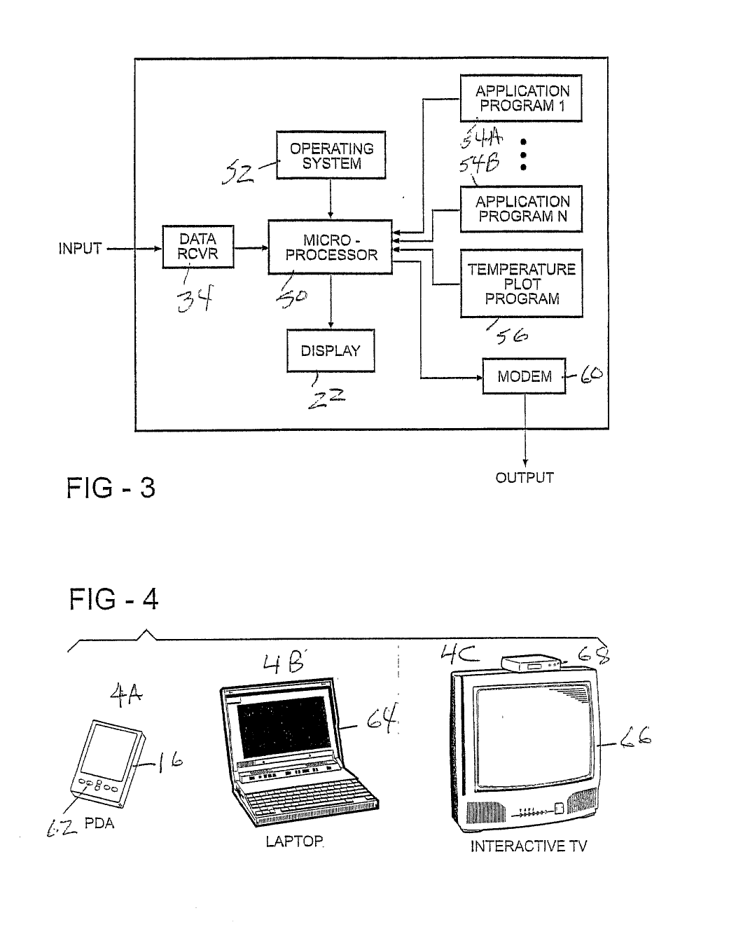

The electronic internal arrangement of the information appliance 16 is illustrated in FIG. 3 which shows the data receiver 34 as being integral with the information appliance. Input information from the receiver 34 is provided to a microprocessor 50 which controls the operation of the information appliance. The microprocessor 50 operates in conjunction with an operating system 52. The information appliance includes some number of application programs. Application programs 54a and 54b are illustrated. For example, if the information appliance 16 were a PDA, one of these programs might constitute an address program and another a calendar program. If the information appliance 16 were an interactive TV receiver, one of the application programs would constitute a program schedule and another might constitute a preferred programs list. If the information appliance 16 were a personal computer, the application programs might include word processing, spreadsheet and the like. In accordance with the present invention, the information appliance 16 includes another application program 56 which generates a plot of temperatures on the display 22 based on data from the receiver 34. The application program 56 may be loaded into the information appliance in any conventional way, such as loading from the Internet or via a CD. The information appliance 16 further includes a modem 60 which can be used to transmit the stored temperature/time signals to the remote computer 24 through the Internet or other public networks.

FIGS. 4a, 4b and 4c illustrate typical forms of information appliances. FIG. 4a illustrates the PDA 16 with its display screen 22 and operator control buttons 62. Certain cell phones operate like PDAs or have PDAs incorporated within them and are contemplated as the type of information appliances which could be used with the present invention. FIG. 4b illustrates a personal computer 64, which might constitute either a laptop or a desktop unit. When equipped with an appropriate temperature plot application program such as 56, the personal computer 64 could be used with the present invention. FIG. 4c illustrates a television receiver 66 with a set top box 68 that converts it into an interactive TV receiver. The set top box will typically have a data receiver, either in the form of RF or IR, for receiving data and will have a connection with the Internet for providing the data to the remote computer 24. The temperature sensor and its associated assembly 14 might transmit directly to the set top box 68 or to an information appliance such as PDA 62 which in turn communicates with the interactive television receiver set top box 68 to communicate to the Internet and to generate a display of the time/temperature on the television receiver. Each of the information appliances can also display messages received through the Internet from a healthcare professional who has reviewed the time/temperature plot 46, providing medical advice.

FIG. 5 illustrates one form of body mounted temperature sensor. The sensor itself 70 might constitute a thermistor, temperature sensitive semiconductor or other form of device for generating an electrical signal as a function of temperature. The sensor might include an oscillator having a frequency which is a function of the temperature and an integrator to generate a DC signal proportional to the oscillation frequency. Alternatively, the frequency itself can be used as a temperature dependent signal by the subsequent circuitry. The sensor is attached to the middle of a flexible strap, preferably elastic, 72 which has opposed Velcro sections 74 in a complementary manner on its ends for securement to a limb. The memory, associated electronics and transmitter 76 are electrically connected to the sensor 70 and also supported on the strap 72. As illustrated in FIG. 6, the electronics 76 could include a female receptacle 78 for direct electrical connection to an information appliance and a pushbutton 80. The pushbutton might be used to initiate temperature measurements or to turn the device on and off. A battery, such as a flexible strip type, might also be associated with the electronics 76.

In an alternative embodiment of the invention, the sensor 14 could only take temperature measurements when prompted by a signal from the information appliance 16. That signal could be provided either through wired connection or wirelessly, and the clock 30 could be incorporated in the information appliance. The temperature signal could be provided to the information appliance receiver 34 immediately upon generation, eliminating the need for the memory 32 in the sensor assembly. The temperature measurement could be triggered by the pushbutton 80, by an electrical signal provided through wired connection, or through a wireless connection.

Having thus described my invention, I claim:

1. A system for monitoring and recording the body temperature of a subject comprising:
a thermal sensor adapted to be supported in contact with the body of the subject so as to generate an electrical signal representative of the subject's body temperature;
a microprocessor-based, programmable information appliance having a display;
a clock adapted to generate electrical signals as a function of the time;
an application program for the appliance adapted to process the electrical signals generated by the sensor and electrical signals representative of the time of generation of the signals from the clock to create a display constituting a plot of body temperature versus time; and
means for transferring electrical signals from the sensor to the information appliance whereby the information appliance displays a plot of the subject's body temperature over a period of time.

2. The system of claim 1 further including:
a remote computer;
a public network; and
an application program in the information appliance adapted to transfer information relating to the subject's temperature over a period of time to said remote computer via a public network.

3. The system of claim 1 wherein said clock is supported in association with said sensor on the body of the subject and further including a memory associated with said sensor on the body of the subject and adapted to receive electrical signals from said sensor representative of the body temperature of the subject and simultaneously signals from the clock representative of the time of occurrence of said electrical signals representative of the body temperature of the subject and to store signals from the sensor and the time signals.

4. The system of claim 1 wherein said means for transferring signals from the temperature sensor to the information appliance comprises a wireless transmitter supported on the body of the subject and a receiver for transmitted wireless signals electrically connected to the information appliance.

5. The system of claim 4 including an electrical battery supported on the body of the subject powering said sensor and wireless transmitter.

6. The system of claim 1 in which the information appliance comprises a personal computer.

7. The system of claim 1 wherein the information appliance comprises a personal digital assistant.

8. The system of claim 1 in which the information appliance comprises an interactive television receiver.

9. The system of claim 7 further including:
a remote computer;
a public network;
an interactive television receiver connected to the public network; and
application software associated with the personal digital assistant for transmitting signals representative of the subject's temperature over a period of time to the remote computer by transferring such information to said interactive television receiver for retransmission through said public network to the remote computer.

10. A system for monitoring the body temperature of a subject and for generating a display of the temperature over time, comprising:
a temperature sensor adapted to be supported in association with the body of the subject so as to generate an electrical signal representative of the subject's body temperature;
a clock adapted to generate electrical signals as a function of real time;
a microprocessor-based, programmable information appliance, having a display;
an application program for the appliance adapted to process electrical signals generated by the sensor and electrical signals generated by the clock to create a display constituting a plot of body temperature versus time;
a remote computer;
a public network; and
an application program in the information appliance adapted to transfer information relating to the subject's temperature over a period of time to said remote computer via public network for display on the remote computer and access by healthcare professionals.

11. The system of claim 10 further including the transmission of diagnostic information by the healthcare professional, based on the display of body temperature versus time, over the public network, to the information appliance, for display to the user.

12. The system of claim 10 wherein the information appliance further includes additional application programs unrelated to the generation of a time/temperature plot.

13. The system of claim 10, further including a memory associated with the body supported sensor for receiving and storing signals representative of the measured body temperature and the time of their occurrence.

14. The system of claim 13 wherein said body temperature measurements are made at predetermined intervals under control of the clock.
